(19) United States
(12) Patent Application Publication
(10) Pub. No.: US 2008/0160415 A1
(43) Pub. Date: Jul. 3, 2008

(54) LITHIUM ION BATTERY

(75) Inventors: Shinya Wakita, Fukushima (JP); Izaya Okae, Fukushima (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 11/745,941

(22) Filed: May 8, 2007

(30) Foreign Application Priority Data
May 15, 2006 (JP) JP2006-135669

(51) Int. Cl. H01M 4/48

(52) U.S. Cl. 429/231.5; 429/209; 429/231.9; 429/231.6; 429/218.1

(57) ABSTRACT

A lithium ion battery including a cathode provided with a cathode active material on a cathode current collector, an anode and an electrolyte solution, wherein the cathode active material layer contains nano-particles of ceramic is provided. The lithium ion battery suppresses the growth of a cathode film on the cathode, improves energy density and has excellent cycle characteristics.

### CROSS REFERENCES TO RELATED APPLICATIONS

The present application claims priority to Japanese Patent Application JP 2006-135669 filed on May 15, 2006, the entire contents of which is being incorporated herein by reference.

### BACKGROUND

The present disclosure relates to a lithium ion battery including a cathode using a cathode active material capable of occluding or releasing lithium ions.

The significant development of portable electronic technologies in recent years has permitted of the recognition of electronic devices such as portable telephones, laptop computers and personal digital assistants (PDAs) as fundamental technologies supporting a high degree of information-oriented society. Also, research and developments concerning high functionalization of these devices are being energetically made, and the power consumption of electronic devices is steadily increasing in proportion to this. On the other hand, it is demanded of these electronic devices to work for a long time and it has been inevitably desired to develop secondary batteries having a high energy density which are driving power sources.

The energy density of a battery provided within an electronic device is preferably higher from the viewpoint of the occupied volume and weight of the battery. In order to cope with this demand, there is a proposal of a secondary battery using lithium Li as an electrode reactive material. Among these secondary batteries, a lithium ion secondary battery using a carbon material that can be doped or dedoped with a lithium ion as the anode has come to be provided within almost all devices because it has a high energy density.

However, such a battery has been already utilized for charging or discharging up to a range close to the theoretical capacity of a carbon material. For this, studies as to measures taken to raise energy density are being made to increase the thickness of an active material layer, thereby increasing the ratio of the active material layer and decreasing the ratio of a current collector and a separator as shown in Japanese Patent Application Laid-Open (JP-A) No. 9-204936.

However, the diffusion of lithium ions in the cathode is insufficient in batteries improved in energy density and therefore, measures taken to improve the diffusion of lithium ions are strongly desired. In the case of, particularly, increasing the thickness of the active material layer, the area of the electrode is decreased because the length of the electrode is decreased to manufacture a battery having the same size. For this reason, there is the problem that current density increases so that the diffusion of lithium in the surface of the cathode is unable to catch up with the increase in charging density, thereby causing excessive voltage build-up across the cathode, with the result that the electrolyte solution is oxidation-decomposed in the vicinity of the cathode, thereby increasing the growth of a film on the surface of the cathode.

The film formed on the surface of the cathode causes a rise in the charge-transfer resistance of the battery, resulting in a significant deterioration in cycle characteristics. Such a problem makes it difficult to more thicken the cathode active material layer than in the case of current batteries with the intention of improving energy density.

There is therefore a proposal concerning a cathode active material obtained by applying an aluminum oxide to a part of the surface of particles of lithium cobaltate which is a lithium-cobalt complex oxide as shown in Japanese Patent Application Laid-Open (JP-A) No. 2002-151077.

In JP-A-2002-151077, an aluminum salt is added in an aqueous solution in which lithium cobaltate particles are dispersed, the pH of the solution is adjusted to allow fine aluminum hydroxide colloid to adsorb to the surface of the lithium cobaltate particles. Then, the resulting lithium cobaltate particles are heat-treated at 600 to 900° C. in an oxidizing atmosphere, to obtain a cathode active material coated with an aluminum oxide contained in an amount of 1 to 4 mol % based on cobalt included in a lithium cobaltate particle powder. In a nonaqueous electrolyte secondary battery using such a cathode active material, it is regarded as possible to suppress the oxidation-decomposition reaction of tetravalent cobalt on the surface of the cathode active material particles with the electrolyte solution, the reaction being predicted under a circumstance of high temperatures or a charged voltage as high as 4.8 V or more.

However, according to J. Cho et al, “Journal of The Electrochemical Society”, 148(10), 2001, pp. A1110-A1115, it is reported that if the heat treatment temperature is 700° C. or more, an aluminum element is diffused into the lithium cobaltate particles and forms a solid solution on the surface layer, and therefore, not only the effect of the coating film is not obtained but also a reduction in battery capacity is caused.

Particularly, in the method described in JP-A-2002-151077, an aluminum oxide is chemically combined with a part of the surface of the lithium cobaltate particles, and therefore, a reduction in capacity when the battery is charged excessively is increased beyond the content of the aluminum oxide.

That is why there is a proposal concerning a cathode material in JP-A-2005-276454, in which an aqueous alumina sol solution is added by spraying in a lithium/cobalt complex oxide powder in which a fluid bed is formed by heated air blowing, followed by drying at 400 to 650° C., to thereby form an amorphous alumina coating layer having an amount of 1.0 to 8.0 parts by weight for 100 parts by weight of the lithium/cobalt complex oxide.

However, a cathode active material manufactured in the same manner as in JP-A-2005-276454 is used when the thickness of the cathode active material layer is thickened in a lithium ion secondary battery using an organic solvent electrolyte solution, alumina stuck while it is coagulated is present on the surface of the cathode active material. For this reason, although the diffusibility of lithium is improved, such a problem arises that because the cathode active material layer is bulky, its volume density is not raised and the load of a press is increased. Also, there is a fear that a reduction in cycle characteristics cannot be restrained due to, for example, the problem that coagulated alumina hinders the electroconductivity between the active materials.

Also, it is necessary to carry out a surface treating step for coating the cathode active material with an aluminum oxide in JP-A-2002-151077 and JP-A-2005-276454, which complicates the production process.

Therefore, it is desired to solve the foregoing problem and to provide a lithium ion battery having a high energy density and excellent cycle characteristics.

### SUMMARY

According to an embodiment, there is provided a lithium ion battery including a cathode provided with a cathode active material layer on a cathode current collector, an anode and an electrolyte solution, wherein the cathode active material layer contains nano-particles of ceramic.

Since, it is so devised in the present disclosure that the cathode is made to contain nano-particles of ceramic having a median diameter less than 1 μm, a cathode film containing ceramic having a small median diameter is formed on the surface of the cathode active material even if the electrolyte solution is decomposed by oxidation. As a consequence, a rise in charge transfer resistance in the cathode can be restricted even if the thickness of the cathode active material layer is increased.

According to the embodiment, a lithium ion battery can be obtained which suppresses the growth of a cathode film on the cathode, is improved in energy density and has excellent cycle characteristics.

These and other features will become more apparent in light of the following detailed description, as illustrated in the accompanying drawings.

Additional features and advantages are described herein, and will be apparent from, the following Detailed Description and the figures.

### BRIEF DESCRIPTION OF THE FIGURES

FIG. 1 is a sectional view showing an embodiment of a lithium ion battery; and

FIG. 2 is a sectional view showing an electrode of a lithium ion battery.

### DETAILED DESCRIPTION

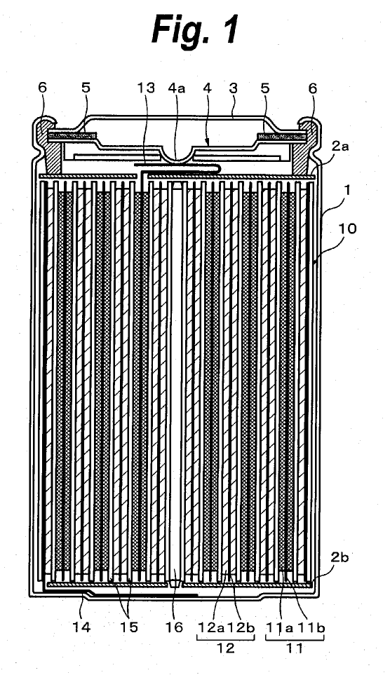

FIG. 1 is an example of a sectional view of a lithium ion secondary battery according to an embodiment. The battery is one called a cylinder type and is provided with a cell element 10 obtained by winding a band-like cathode 11 and an anode 12 through a separator 15 in a battery can 1 having an almost hollow cylindrical form. The battery can 1 is, for example, constituted of iron plated with nickel, and one of the ends thereof is closed and the other is opened. A pair of insulation plates 2a and 2b are disposed perpendicular to the winding peripheral surface in such a manner as to sandwich the cell element 10 inside of the battery can 1.

Examples of the material of the battery can 1 include iron Fe, nickel Ni, stainless SUS, aluminum Al and titanium Ti. The battery can 1 may be, for example, plated to prevent electrochemical corrosion caused by the nonaqueous electrolyte solution along with charging and discharging of the battery. A battery lid 3, a safety valve mechanism 4 disposed on the inner side of the battery lid 3 and a positive temperature coefficient (PTC) element 5 are fitted to the open end of the battery can 1 by caulking these parts through an insulation sealing gasket 6, and the inside of the battery can 1 is sealed. The battery lid 3 is made of, for example, the same material that is used for the battery can 1. The safety valve mechanism 4 is so devised that it is electrically connected to the battery lid 3 through the PTC element 5, and when the internal pressure of the battery is raised to a fixed value or more by a development of internal short circuits or heating from the outside, a disk plate 4a is reversed to cut off the electrical connection between the battery lid 3 and the cell element 10. The PTC element 5 serves as an element that limits the amount of current by an increase in resistance associated with a rise in temperature to thereby prevent abnormal generation of heat due to a large current, and it is made of, for example, barium titanate type semiconductor ceramics. The insulating sealing gasket 6 is made of, for example, an insulating material and the surface of the insulating material is coated with asphalt.

The cell element 10 is wound around a center pin 16. A cathode terminal 13 and an anode terminal 14 are connected to the cathode 11 and the anode 12 of the cell element 10, respectively. The cathode terminal 13 is welded to the safety valve mechanism 4 to electrically connect to the battery lid 3, and the anode terminal 14 is welded to the battery can 1 to electrically connect to the battery can 1.

The structure of the battery element 10 received in the battery can 1 is explained below.

(Cathode)

The cathode 11 is obtained by forming a cathode active material layer 11a containing a cathode active material on both surfaces of a cathode current collector 11b. The cathode current collector 11b is constituted of a metal foil such as an aluminum foil, nickel foil or stainless foil.

The cathode active material layer 11a is formed by formulating, for example, a cathode active material, ceramic, a conductive agent and a binder. In an embodiment, the cathode active material, conductive agent and binder should be at least substantially uniformly dispersed, but there is no limitation to the mixing ratio of these materials.

As the ceramic, for example, an inorganic oxide is used, and specifically, Al₂O₃, SiO₂, ZrO₂, MgO, Na₂O, TiO₂ or the like may be used. Among these compounds, Al₂O₃ is particularly preferable. This is because the diffusion of lithium ions on the surface of Al₂O₃ particles is superior. These inorganic oxides may be used either singly or in combinations of two or more. As such ceramic, nano-particles having a median diameter less than 1 μm are used. Also, as to the median diameter, ceramic having a median diameter of 50 nm or less is more preferable and ceramic having a median diameter of 12 nm or less is even more preferable. It is to be noted that the median diameter is a particle diameter at an accumulation of 50% obtained in a laser diffraction method (JIS Z8825-1).

This leads to the decomposition of a part of the electrolyte solution when the battery is first charged, and a complex SEI film which is a cathode film containing ceramic nano-particles is thus formed on the surface of the cathode active material. The formation of such a cathode film enables lithium ions to transfer on the surface of ceramic having high ion diffusibility in the surface part of the cathode active material layer having high charge transfer resistance. This makes it possible to improve ion diffusibility on the surface of the anode active material where the diffusion of ions is generally hindered.

The reason why the ceramic nano-particles are used is that when ceramic having a median diameter of 1 μm or more is used, ion diffusibility in the cathode film formed on the surface of the cathode active material can be only insufficiently improved. Because the film to be formed on the surface of the cathode active material resulting from the decomposition of the electrolyte solution has a thickness of about several nm, the surface of ceramic facing the electrolyte solution is increased when ceramic having a median diameter of 1 μm or more is mixed. Because ionic diffusibility on the surface of ceramic is lower than that of the electrolyte solution, the diffusion of ions may be hindered if the particle diameter of the ceramic is excessively large. Also, the surface area of ceramic contributing to the diffusion of ions in the surface of the cathode active material is reduced and therefore, the effect of improving ionic diffusibility on the surface of the cathode active material is reduced, with the result that it is difficult to restrict the precipitation of lithium.

Also, as to the particle diameter of the above ceramic, its median diameter is designed to be preferably 50 nm or less and more preferably 12 nm or less. A cathode film more superior in ion diffusibility can be formed by using ceramic having a smaller diameter.

As the cathode active material, a known cathode active material capable of occluding and releasing lithium ions may be used, and a metal oxide, metal sulfide or a specific polymer may be used according to the type of a battery to be intended. Examples of the cathode active material include lithium oxides, lithium sulfides, phase compounds containing lithium or lithium-containing compounds such as lithium phosphate compounds.

Among these compounds, preferable compounds are complex compounds containing lithium and a transition metal element as typified by LiₓMO₂ or LiₓM₂O₄ (where M represents one or more transition metals and x is generally given by the following equation: 0.05≦x≦1.10, though depending on the charge or discharge condition of the battery) or phosphoric acid compounds typified by Li_{y}MPO₄ (where M represents one or more transition metals and y is generally given by the following equation: 0.05≦y≦1.10). As the transition metals constituting these compounds, at least one of cobalt Co, nickel, manganese Mn, iron, aluminum, vanadium V and titanium Ti is selected.

Specific examples of the lithium complex oxide include lithium/cobalt complex oxides (LiₓCoO₂), lithium/nickel complex oxides (LiₓNiO₂), lithium/nickel/cobalt complex oxides (LiₓNi_{z}Co_{1-z}O₂) (wherein z<1)) and lithium/nickel/cobalt/manganese complex oxides (LiₓNi_{z(1-v-w)}CoᵥMn_{w}O₄) (wherein v+w<1)).

Also, specific examples of the phosphoric acid compound include lithium-iron-phosphoric acid compounds (LiFePO₄) and lithium-iron-manganese-phosphoric acid compounds (LiFe₁₋ᵤMn₁₋ᵤPO₄ (wherein u<1)). Such compounds can generate high voltage by using it as the cathode active material, are superior in energy density and are therefore preferable materials.

Moreover, other metal compounds or polymer materials are exemplified. Examples of the above other metal compound include oxides such as titanium oxide, vanadium oxide and manganese dioxide and disulfides such as titanium sulfide and molybdenum sulfide. Examples of the polymer material include polyanilines and polythiophenes.

As the cathode material, the aforementioned cathode active materials may be used in combinations of two or more.

As the conductive agent, one or two or more of carbon materials such as graphite, carbon black, ketchen black or graphite may be used singly or in combinations of two or more, though any material may be used without any particular limitation insofar as it may be mixed in the cathode material in a proper amount to impart conductivity. Also, besides carbon materials, metal materials or conductive polymer materials may be used insofar as they have conductivity.

Examples of the binder include fluorine type polymers such as polyvinyl fluoride, polyvinylidene fluoride and polytetrafluoroethylene and synthetic rubbers such as styrenebutadiene type rubbers, fluorine type rubbers and ethylenepropylenediene rubbers, though known binders used usually for the cathode binder of batteries of this type. These binder materials may be used either singly or in combinations of two or more.

(Anode)

The anode 12 is obtained by forming the anode active material layer 12a containing an anode active material on both or one surface of the anode current collector 12b. The anode current collector 12b is made of a metal foil such as a copper foil, nickel foil, stainless foil or the like.

The anode active material layer 12a is formed by compounding an anode active material, and as required, a conductive agent and a binder. There is no limitation to the mixing ratio of the anode active material, conductive agent, and binder like the cathode active material.

As the anode active material, a carbon material which can be doped or dedoped with lithium is used. Specifically, examples of the carbon material which can be doped or dedoped with lithium include graphite, non-easy-graphitizable carbon material, easy-graphitizable carbon material and highly crystalline carbon material having a developed crystal structure. More specifically, carbon materials such as thermally decomposed carbons, cokes (pitch cokes, needle cokes and petroleum cokes), graphite, glassy carbons, organic high-molecular compound baked bodies (those obtained by baking and carbonizing phenol resins, furan resins or the like at proper temperatures), carbon fibers and activated carbon may be used.

Particularly, it is preferable to use mesophase globules. The reason is that because the graphite layer in the particle is oriented radially and the hardness of the particles is high, the active material in the vicinity of the surface of the electrode is scarcely crushed even if the electrode is press-molded, so that the orientation of the graphite layer is maintained in the direction of the thickness of the electrode, which allows the graphite layer to have the excellent ability to accept lithium ions. These mesophase globules belong to the so-called easy-graphitizable carbons and are liquid crystal globules generated as an intermediate in a system in which the phase participating in the reaction is changed from a liquid phase to a solid phase when the organic compound is heat-treated.

In order to obtain this mesophase globules, coal or petroleum pitches such as coal tar pitch is heat-treated at 400° C. to 500° C. in an inert atmosphere to produce liquid crystal globules, which are separated from the pitch matrix as a quinoline insoluble content. After that, the grain size is adjusted by crushing or classification according to the need.

These carbon materials are very reduced in the change of the crystal structure produced in charging or discharging and it is possible to obtain not only a high charging and discharging capacity but also good charging and discharging cycle characteristics and are therefore preferable. Particularly, graphite has high electrochemical equivalent and can obtain a high energy density and is preferable. The above graphite may be either natural graphite or artificial graphite.

As the above graphite, those having the following characteristics are preferable: lattice spacing d₀₀₂ in the direction of the C axis in X-ray diffraction is 0.338 nm or less, and the peak strength ratio (I_{D}/I_{G}) exceeds 0.01 and 2.0 or less when the strength of a peak present in a wavelength region from 1570 cm⁻¹ or more and 1630 cm⁻¹ or less is I_{G} and the strength of a peak present in a wavelength region from 1350 cm⁻¹ or more and 1370 cm⁻¹ or less is I_{D} in a Raman spectrum using an argon laser having a wavelength of 514.5 nm is used. The lattice spacing d₀₀₂ can be measured by an X-ray diffraction method (Sugio OTANI et al., Carbon Fibers, pp 733-742 (1986), published by Kindai Henshu) using a CuKαray as the X ray and high purity silicon as the standard material. Also, the true density of the graphite is preferably 2.10 g/cm³ or more and more preferably 2.18 g/cm³ or more.

Moreover, it is preferable that the bulk density of the graphite be 1.2 g/cm³ or more and the breaking strength of the graphite 50 MPa or more. This is because the layer structure of the graphite can be maintained and the lithium occlusion and releasing reaction can be kept smoothly even if the anode active material 12a is pressed to increase the volume density thereof. The breaking strength of graphite particles can be found from the following equation.

St(Sx)=2.8P/(π×d×d)

Here, St (Sx) represents a breaking strength [Pa], P represents a power [N] applied in the test and d denotes the median diameter [mm] of particles. In this case, the median diameter d may be measured, for example, by a laser diffraction type grain distribution measuring device.

As the graphite difficult to graphitize, those having the following characteristics are preferable: the spacing of the (002) plane is 0.37 nm or more, true density is less than 1.70 g/cm³ and no exothermic peak is shown at 700° C. or more in differential thermal analysis (DTA) in the air.

Also, as the aforementioned other material, a lithium metal, lithium alloy or complex material of a metal material which can be doped or dedoped with lithium and a carbon type material is used. As the metal material, various types of metals may be used and metals, semimetals, alloys or compounds which can be combined with lithium to form alloys may be used. When metal lithium is used, a method in which a powder of metal lithium is made into a coating film by using a binder is unnecessarily used but a method in which a rolled lithium metal foil is applied to a current collector under pressure may be used without any problem. These materials are preferable because a high energy density can be obtained. Also, when these materials are used together with the aforementioned carbon materials, this is more preferable because a high energy density and stable cycle characteristics can be obtained.

Examples of the metals or semimetals which can constitute the anode material include tin Sn, lead Pb, magnesium Mg, aluminum Al, boron B, gallium Ga, silicon Si, indium In, zirconium Zr, germanium Ge, bismuth Bi, cadmium Cd, antimony Sb, silver Ag, zinc Zn, arsenic As, haffium Hf, yttrium Y and palladium Pd.

Among these metals, single metals or semimetal elements of the 4B group in the short periodic type periodic table or alloys or compounds containing these metals as its structural element are preferable, and those containing at least one of silicon and tin as its structural element are particularly preferable. Silicon and tin are highly improved in the ability to occlude and release lithium and make it possible to obtain a high energy density.

Examples of the alloy of tin include those containing at least one kind selected from the group including silicon, nickel, copper, iron, cobalt, manganese, zinc, indium, silver, titanium Ti, germanium, bismuth, antimony Sb and chromium as the second structural element other than tin. Examples of the alloy of silicon include those containing at least one kind selected from the group including tin, nickel, copper, iron, cobalt, manganese, zinc, indium, silver, titanium, germanium, bismuth, antimony and chromium as the second structural element other than silicon.

Examples of the tin compound or silicon compound include those which contain oxygen O or carbon C and may contain the aforementioned second structural element in addition to tin and silicon.

As the binder, the same one that is used for the cathode may be used.

(Electrolyte Solution)

The nonaqueous electrolyte solution is prepared, for example, by appropriately combining an organic solvent and an electrolyte salt. As the organic solvent, any material generally used in this type of battery may be used. Examples of the organic solvent include room temperature molten salts such as 4-fluoro-1,3-dioxolan-2-one, ethylene carbonate, propylene carbonate, vinylene carbonate, dimethyl carbonate, ethylmethyl carbonate, γ-butyrolactone, γ-valerolactone, 1,2-dimethoxyethane, 1,2-diethoxyethane, tetrahydrofuran, 2-methyltetrahydrofuran, 1,3-dioxolan, 4-methyl-1,3-dioxolan, diethyl ether, methyl acetate, methyl propionate, ethyl propionate, acetonitrile propionate, propionitrile, anisole, ester acetate, ester butyrate, glutaronitrile, adiponitrile, methoxyacetonitrile, 3-methoxypropylonitrile, N,N-dimethylformamide, N-methylpyrrolidinone, N-methyloxazolidinone, nitromethane, nitroethane, sulfolane, methylsulfolane, dimethyl sulfoxide, trimethyl phosphate, triethyl phosphate, ethylene sulfite and bistrifluoromethylsulfonylimidotrimethylhexylammonium. If, among these compounds, at least one among the group consisting of 4-fluoro-1,3-dioxolan-2-one, ethylene carbonate, propylene carbonate, vinylene carbonate, dimethyl carbonate, ethylmethyl carbonate and ethylene sulfite is mixed, excellent charging or discharging capacity characteristics and charging and discharging cycle characteristics can be obtained, which is preferable.

As the above electrolyte salt, one dissolved in the above organic solvent is used and the electrolyte salt is produced by combining a cation with an anion. As the cation, an alkali metal or an alkali earth metal is used and as the anion, Cl⁻, Br⁻, I⁻, SCN⁻, ClO₄⁻, BF₄⁻, PF₆⁻, CF₃SO₃⁻ or the like is used. Specific examples of the electrolyte salt include lithium chloride LiCl, lithium perchlorate LiClO₄, lithium hexafluoroarsenate LiAsF₆, lithium hexafluorophosphate LiPF₆, lithium tetrafluoroborate LiBF₄, lithium tetraphenylborate LiB(C₆H₅)₄, lithium methanesulfonate LiCH₃SO₃, lithium trifluoromethanesulfonate LiCF₃SO₃, bis(pentafluoroethanesulfonyl)imidolithium Li(C₂F₅SO₂)₂N, bis(trifluoromethanesulfonyl)imidolithium Li(CF₃SO₂)₂N, tris(trifluoromethanesulfonyl)methyllithium LiC(CF₃SO₂)₃ and lithium bromide (LiBr). These compounds may be used either singly or in combinations of two or more. Among these compounds, it is preferable to use LiPF₆ mainly.

(Separator)

The separator 15 is produced, for example, by using a porous film made of a polyolefin type material such as polypropylene PP or polyethylene PE or a porous film made of an inorganic material such as ceramic nonwoven fabric. The separator 15 may have a structure in which two or more porous films are laminated. Among these compounds, a porous film such as polyethylene or polypropylene is most effective.

Generally, as to the thickness of the separator 15, a separator having a thickness of preferably 5 μm or more and 50 μm or less and more preferably 7 μm or more and 30 μm or less may be used. If the separator 15 is too thick, the amount of the active material to be filled is decreased, leading not only to a reduction in battery capacity but also to a reduction in ionic conductivity, resulting in deteriorated current characteristics. If the separator 15 is too thin on the other hand, the mechanical strength of the film is dropped.

Next, one example of a method of producing a lithium ion secondary battery having the above structure is explained.

(Production of a Cathode)

The foregoing cathode active material, ceramic, binder and conductive agent are uniformly mixed to form a cathode combined agent. This cathode combined agent is dispersed in a solvent such as N-methyl-2-pyrrolidone and is made into a slurry by using a ball mill, sand mill, biaxial kneader or the like according to the need. Then, this slurry is uniformly applied to both surfaces of the cathode current collector 11b by a doctor blade method or the like. Moreover, the cathode current collector is dried at high temperatures to remove a solvent and then compression-molded by a roll press machine or the like to form a cathode material layer 11a. At this time, the cathode active material layer 11b may be formed by applying the cathode combined agent to the cathode current collector 11b.

Any of inorganic solvents and organic solvents may be used as the solvent without any particular limitation insofar as it is inert to the electrode material and can dissolve the binder.

Also, no particular limitation is imposed on the coating apparatus and a slide coater, extrusion-type die coater, reverse roller, gravure coater, knife coater, kiss coater, micro-gravure coater, rod coater or blade coater may be used. Also, though no particular limitation to the drying method, natural drying, air drying, hot air drying, infrared heater, far-infrared heater or the like may be used.

At this time, the thickness of the cathode active material layer 11a is preferably adjusted to 70 μm or more and 130 μm or less on one surface and a total of 140 μm or more and 260 μm or less on both surfaces. This is because particularly high ion diffusing effect is obtained when the thickness is in the above range. In this lithium ion secondary battery, the thickness of the cathode active material layer 11a can be made larger than that of a cathode active material used currently, by blending ceramic nano-particles in the cathode. For this reason, the amount of lithium ions with which the anode can be doped is increased and also, the volumes of the cathode current collector 11b, anode current collector 12b and separator 15 are decreased in the battery, whereby energy density can be improved. However, when the cathode active material layer 11a is made too thick, the effect of improving ionic diffusibility due to the blending of ceramic is scarcely obtained. This causes excessive voltage build-up across the cathode, with the result that the electrolyte solution is oxidation-decomposed, which deteriorates battery characteristics such as heavy load characteristics and cycle characteristics. Also, when the cathode active material layer 11a is too thin, the energy density is not improved because the amount of lithium ions with which the anode can be doped is reduced.

It is to be noted that the thickness and volume density of the above cathode active material layer 11a are made to be those of the cathode active material layer 11a formed on the cathode current collector 11b in the cathode production process and obtained after the compression molding.

One cathode terminal 13 connected by spot welding or ultrasonic welding is deposited on one end of the cathode 11. This cathode terminal 13 is preferably a metal foil or network. However, any material may be used as the cathode terminal 13 without any problem even if it is not a metal insofar as it is stable electrochemically and chemically and is allowed to conduct. Examples of the material used for the cathode terminal 13 include Al. The cathode terminal 13 is so devised that it is deposited on the exposed part of the cathode current collector disposed at the end of the cathode 11.

(Production of an Anode)

The foregoing anode active material, binder and ceramic nano-particles are uniformly mixed to form an anode combined agent. This anode combined agent is dispersed in a solvent such as N-methyl-2-pyrrolidone and is made into a slurry. At this time, a ball mill, sand mill, biaxial kneader or the like may be used like the case of the cathode combined agent. Then, this slurry is uniformly applied to both surfaces of the anode current collector by a doctor blade method or the like. Moreover, the anode current collector is dried at high temperatures to remove a solvent and then compression-molded by a roll press machine or the like to form an anode active material layer 12a. At this time, like the case of the cathode, the anode active material layer 12a may be formed by applying the anode combined agent to the anode current collector 12b.

As the solvent, any solvent may be used without any particular limitation insofar as it is inert to the electrode materials and can solve the binder and any of an inorganic solvent and organic solvent may be used similarly to the case of the cathode.

Also, one anode terminal 14 is welded to one end of the anode 12 by spot welding or ultrasonic welding. Any material may be used as the anode terminal 14 without any problem even if it is not a metal insofar as it is stable electrochemically and chemically and is allowed to conduct. Examples of the material used for the anode terminal 14 include copper and nickel. It is so devised that the anode terminal 14 is deposited on the exposed part of the anode current collector formed at the end of the anode 12 in the same manner as in the case of the part where the cathode terminal is welded.

(Production of a Cell Element)

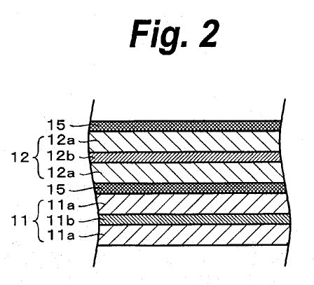

As shown in FIG. 2, the cathode 11, the anode 12 and the separator 15 are laminated in the order of the cathode 11, the separator 15, the anode 12 and the separator 15 and the resulting laminate is wound to make a cell element 10. Next, the end of the cathode terminal 13 is connected to the battery lid 3 with the built-in safety valve mechanism 4 and PTC element 5, by welding or the like and also, the cell element 10 is received in the battery can 1. At this time, the cell element 10 is received in such a manner that the lead-out side of the anode terminal 14 on the wound surface of the cell element 10 is covered with the insulating plate 2a made of an insulating resin. After that, one electrode bar is inserted from the center of the wound cell element, another electrode bar is disposed on the outside of the bottom of the battery can 1 to carry out resistance welding, and the anode terminal 14 is welded to the battery can 1. In this case, the cell element 10 may be received after the anode terminal 14 is first connected to the battery can 1.

After the anode terminal 14 is welded to the battery can 1, a center pin 16 is inserted, an insulating plate 2b is also disposed at the wound surface part located at the opening end of the battery can, and then, an electrolyte solution is poured to impregnate the separator with the electrolyte solution. In succession, the battery lid 3, the safety valve mechanism 4 and the PTC element 5 are fixed to the open end of the battery can 1 by caulking these parts through the insulation sealing gasket 6 and the inside of the battery can 1 is thereby sealed.

As the cathode terminal 13, it is necessary to use one having a certain length in view of the production process. This is because the opening end of the battery can is sealed after the cathode terminal 13 is connected with the safety valve mechanism 4 disposed on the battery lid 3 in advance. As the cathode terminal 13 is shorter, it is more difficult to connect the cathode terminal 13 with the battery lid 3. Therefore, the cathode terminal 13 is received in the battery in the condition that it is bent in an almost U-form.

Also, though the anode terminal 14 is connected with the battery can 1 to produce a lithium ion secondary battery in the above embodiment, the cathode terminal 13 may be connected with the battery can 1 to form a cathode can.

When the lithium ion secondary battery produced in the above manner is charged, for example, lithium ions are released from the cathode active material layer 11a and occluded in the anode active material layer 12a through the electrolyte solution. Also, when a discharge operation is carried out, for example, lithium ions are released from the anode active material layer 12a and occluded in the cathode active material layer 11a through the electrolyte solution. At this time, the area of the cathode active material layer 11a is reduced and the density of current across the cathode 11 during charging is increased because the cathode active material layer 11a is thickened. However, the nano-particles of ceramic are contained in the cathode, so that the diffusion of lithium is improved and therefore, a better cathode film is formed on the cathode 11, whereby a rise in film resistance and charge transfer resistance can be limited. Therefore, excellent cycle characteristics can be obtained and also, an improvement in energy density can be made since the thickness of the cathode can be increased.

### EXAMPLES

This embodiments are explained in detail below by way of non-limiting examples.

### Example 1

The type of ceramic to be contained in a cathode was changed to produce lithium ion secondary batteries and the capacity retaining factor of each battery after 100 cycles was measured.

### Example 1-1

(Production of a Cathode)

A cylindrical secondary battery as shown in FIG. 1 was produced. First, lithium carbonate Li₂CO₃ and cobalt carbonate CoCO₃ were mixed in the molar ratio, Li₂CO₃:CoCO₃=0.5:1 and the mixture was baked at 900° C. in the air for 5 hours to obtain a lithium/cobalt complex oxide LiCoO₂. The obtained LiCoO₂ was measured by X-ray diffraction, to find that its peak exactly accorded to the peak of LiCoO₂ registered in the JCPDS (Joint Committee of Powder Diffraction Standard) File. Next, this lithium/cobalt complex oxide is crushed into a powder having a particle diameter (median diameter) of 15 μm at an accumulation of 50% obtained in a laser diffraction method to obtain a cathode active material.

In succession, 95 parts by weight of the lithium/cobalt complex oxide powder and 5 parts by weight of a lithium carbonate powder Li₂CO₃ were mixed to form a cathode active material. Further, 94 parts by weight of the cathode active material, 3 parts by weight of ketchen black as a conductor and 3 parts by weight of polyvinylidene fluoride as a binder were mixed to make a cathode combined agent. Then, the mixture was simply mixed with Al₂O₃ particles having a median diameter of 25 nm in a ratio of 0.5 parts by weight for 100 parts by weight of the cathode active material and the resulting mixture was dispersed in a solvent, N-methyl-2-pyrrolidone to make a cathode combined agent slurry. Then, this cathode combined agent slurry was applied uniformly to both surfaces of a cathode current collector made of a band-like aluminum foil having a thickness of 20 μm, followed by drying and compression-molding to form a cathode active material layer, thereby producing a cathode. At this time, the cathode active material layer on one surface had a thickness of 102 μm and a volume density of 3.56 g/cm³. Thereafter, an aluminum cathode terminal was fitted to one end of the cathode current collector.

(Production of an Anode)

90 parts by weight of a granular graphite powder made of mesophase globules having a median diameter of 25 μm as an anode active material and 10 parts by weight of polyvinylidene fluoride (PVdF) as a binder were mixed to prepare an anode combined agent. Next, this anode combined agent was dispersed in a solvent, N-methyl-2-pyrrolidone to make an anode combined agent slurry. Here, the properties of the graphite used as the anode active material were as follows: lattice spacing d₀₀₂ in the direction of the C-axis which was calculated by X-ray diffraction was 0.3363 nm, the ratio (I_{D}/I_{G}) of peak strengths obtained by Raman spectrum using an argon laser having a wavelength of 514.5 nm was 0.3, bulk density was 1.50 g/cm³ and breaking strength was 72 MPa. The breaking strength was measured by a small compression tester MCT-W500 manufactured by Shimadzu Corporation and found from the equation 1.

Next, this anode combined agent slurry was applied uniformly to both surfaces of an anode current collector made of a band-like copper foil having a thickness of 15 μm, followed by drying and compression molding to form an anode active material layer, thereby manufacturing an anode. At this time, the anode active material layer on one surface had a thickness of 90 μm and a volume density of 1.80 g/cm³. Thereafter, a nickel anode terminal was fitted to one end of the anode current collector.

(Manufacturing of a Lithium Ion Secondary Battery)

After a cathode and an anode were manufactured, the cathode and the anode were provided alternately side by side through a separator as a laminate which was wound into a coil of many turns, thereby producing a cell element in which the cathode and the anode are facing each other through the separator consisting of porous oriented polyethlene film, of which thickness is 25 μm. Then, the cell element was sandwiched between a pair of insulating plates in such a manner that the wound surface of the cell element was covered with the insulating plates. The anode terminal is welded to a battery can and also, the cathode terminal was welded to a safety valve mechanism to receive the cell element in the battery can.

In succession, an electrolyte solution was poured into the battery can. As the electrolyte solution, an electrolyte solution was used which was obtained by dissolving lithium hexafluorophosphate in a ratio of 1.0 mol/kg as the electrolyte salt in a solvent prepared by blending vinylene carbonate VC, ethylene carbonate EC, diethyl carbonate DEC and propylene carbonate PC in a ratio by volume of 1:40:49:10.

Finally, a battery lid was fitted to the battery can by caulking through a gasket to manufacture a cylinder type lithium ion secondary battery.

### Example 1-2

A lithium ion secondary battery was produced in the same manner as in Example 1-1 except that the ceramic particles to be contained were altered to SiO₂.

### Example 1-3

A lithium ion secondary battery was produced in the same manner as in Example 1-1 except that the ceramic particles to be contained were altered to ZrO₂.

### Example 1-4

A lithium ion secondary battery was produced in the same manner as in Example 1-1 except that the ceramic particles to be contained were altered to MgO.

### Example 1-5

A lithium ion secondary battery was produced in the same manner as in Example 1-1 except that the ceramic particles to be contained were altered to Na₂O.

### Example 1-6

A lithium ion secondary battery was produced in the same manner as in Example 1-1 except that the ceramic particles to be contained were altered to TiO₂.

### Comparative Example 1-1

A lithium ion secondary battery was produced in the same manner as in Example 1-1 except that the ceramic particles were not contained.

(Measurement of Capacity Retaining Factor)

Each lithium ion secondary battery produced in Examples 1-1 to 1-6 and Comparative Example 1-1 was subjected to charge and discharge operations, to examine its capacity retaining factor after 100 cycles. First, the battery was charged under a fixed current of 1 C until the voltage of the battery reached 4.2 V, then the operation was changed to a charging operation carried out at a fixed voltage of 4.2 V and the charging operation was finished when the total charging time reached 4 hours. Then, a discharging operation of the battery was carried out under a fixed current of 1200 mA and finished when the voltage of the battery reached 3.0 V, to measure the discharge capacity in the first cycle.

In succession, a charge-discharge cycle in which the battery was charged until the voltage of the battery reached 4.2 V and discharged until the voltage of the battery reached 3.0 V was repeated 100 times in each Example and Comparative Example, to measure the capacity of the battery in 100th cycle, to find the capacity retaining factor after 100 cycles from the following equation: {(Battery capacity just after 100 cycles)/Battery capacity in the first cycle}}×100.

The capacity retaining factor after 100 cycles in each Example and Comparative Example is shown in Table 1 below.

TABLE 1

| | | | | THICKNESS OF | | |
|---|---|---|---|---|---|---|
| | CERAMIC | | | THE COATING FILM | | CAPACITY |
| | | MEDIAN | CONTENT | ON ONE SURFACE | VOLUME DENSITY | RETAINING |
| | | DIAMETER | [PARTS | OF THE CATHODE | OF THE CATHODE | FACTOR AFTER |
| | TYPE | [nm] | BY WEIGHT] | [μm] | [g/cm³] | 100 CYCLES [%] |
| EXAMPLE 1-1 | Al₂O₃ | 25 | 0.5 | 102 | 3.56 | 92.6 |
| EXAMPLE 1-2 | SiO₂ | 25 | 0.5 | 102 | 3.56 | 89.5 |
| EXAMPLE 1-3 | ZrO₂ | 25 | 0.5 | 102 | 3.56 | 90.1 |
| EXAMPLE 1-4 | MgO | 25 | 0.5 | 102 | 3.56 | 97.4 |
| EXAMPLE1-5 | Na₂O | 25 | 0.5 | 102 | 3.56 | 86.1 |
| EXAMPLE1-6 | TiO₂ | 25 | 0.5 | 102 | 3.56 | 90.3 |
| COMPARATIVE | — | — | 0 | 102 | 3.56 | 51.0 |
| EXAMPLE 1-1 | | | | | | |

As shown in Table 1, the capacity retaining factor was found while changing the type of ceramic as shown in Examples 1-1 to 1-6. In the case of using any of nano-particles of ceramic such as Al₂O₃, SiO₂, ZrO₂, MgO, Na₂O, TiO₂ or the like, more significant improvement in capacity retaining factor than in the case of the lithium ion secondary battery containing no ceramic which was obtained in Comparative Example 1-1 was observed.

### Example 2

Using Al₂O₃ as the ceramic to be contained in the cathode, the content of the ceramic to be contained in the cathode was changed to produce lithium ion batteries and the capacity retaining factor of each battery after 100 cycles was measured.

### Example 2-1

A lithium ion secondary battery was produced in the same manner as in Example 1-1 except that the content of Al₂O₃ particles was altered to 0.05 parts by weight for 100 parts by weight of the anode active material.

### Example 2-2

A lithium ion secondary battery was produced in the same manner as in Example 1-1 except that the content of Al₂O₃ particles was altered to 0.1 parts by weight for 100 parts by weight of the anode active material.

### Example 2-3

A lithium ion secondary battery was produced in the same manner as in Example 1-1.

### Example 2-4

A lithium ion secondary battery was produced in the same manner as in Example 1-1 except that the content of Al₂O₃ particles was altered to 1.0 parts by weight for 100 parts by weight of the anode active material.

### Example 2-5

A lithium ion secondary battery was produced in the same manner as in Example 1-1 except that the content of Al₂O₃ particles was altered to 3.0 parts by weight for 100 parts by weight of the anode active material.

### Comparative Example 2-1

A lithium ion secondary battery was produced in the same manner as in Example 1-1 except that no Al₂O₃ particle was contained.

(Measurement of Capacity Retaining Factor)

Each lithium ion secondary battery produced in Examples 2-1 to 2-5 and Comparative Example 2-1 was subjected to charge and discharge operations, to examine its capacity retaining factors in the first cycle and 100th cycle by using the same method that was used in Example 1, to find the capacity retaining factor after 100 cycles.

The capacity retaining factor after 100 cycles in each Example and Comparative Example is shown in Table 2 below.

TABLE 2

| | | | | THICKNESS OF | | |
|---|---|---|---|---|---|---|
| | CERAMIC | | | THE COATING FILM | | CAPACITY |
| | | MEDIAN | CONTENT | ON ONE SURFACE | VOLUME DENSITY | RETAINING |
| | | DIAMETER | [PARTS | OF THE CATHODE | OF THE CATHODE | FACTOR AFTER |
| | TYPE | [nm] | BY WEIGHT] | [μm] | [g/cm³] | 100 CYCLES [%] |
| EXAMPLE 2-1 | Al₂O₃ | 25 | 0.05 | 102 | 3.56 | 52.3 |
| EXAMPLE 2-2 | Al₂O₃ | 25 | 0.1 | 102 | 3.56 | 88.6 |
| EXAMPLE 2-3 | Al₂O₃ | 25 | 0.5 | 102 | 3.56 | 92.6 |
| EXAMPLE 2-4 | Al₂O₃ | 25 | 1.0 | 102 | 3.56 | 91.1 |
| EXAMPLE 2-5 | Al₂O₃ | 25 | 2.0 | 102 | 3.56 | 64.1 |
| COMPARATIVE | — | — | 0 | 102 | 3.56 | 51.0 |
| EXAMPLE 2-1 | | | | | | |

As shown in Table 2, it is found that in the lithium ion secondary batteries increased in the thickness of the cathode active material layer, Examples 2-1 to 2-5 containing Al₂O₃ are improved in capacity retaining factor than Comparative Example 1-1 containing no Al₂O₃. It is also found that particularly, Examples 2-2 to 2-4 in which the content of Al₂O₃ is 0.1 parts by weight or more and 1.0 parts by weight or less for 100 parts by weight of the cathode active material is improved in capacity retaining factor.

On the other hand, though Examples 2-1 and 2-5 were found to be improved in capacity retaining factor, they were not found to have such a significant effect obtained in Examples 2-2 to 2-4. This is because Example 2 contains Al₂O₃ insufficiently, so that it can be improved in ion diffusibility insufficiently.

In the case of Example 2-5, on the other hand, the reason is that since the content of Al₂O₃ was excessive, the surface of the cathode active material was coated with excessive Al₂O₃ particles having no influence on battery capacity and also, the filling characteristics of the cathode active material was impaired, leading to an increase in press load when the cathode active material layer was molded, with the result that the cathode active material layer was broken.

It is found from the above results that a particularly significant effect is obtained when the content of Al₂O₃ is 0.1 parts by weight or more and 1.0 parts by weight or less.

Also, with regard to ceramics such as SiO₂, ZrO₂, MgO, Na₂O and TiO₂ other than Al₂O₃, the content of each is likewise preferably in a range from 0.1 parts by weight to 1.0 parts by weight for 100 parts by weight of the anode active material.

### Example 3

Using Al₂O₃ as the ceramic to be contained in the anode, the median diameter of the ceramic to be contained in the anode was changed to produce lithium ion secondary batteries and the capacity retaining factor of each battery after 100 cycles was measured.

### Example 3-1

A lithium ion secondary battery was produced in the same manner as in Example 1-1 except that the median diameter of Al₂O₃ particles was changed to 12 nm.

### Example 3-2

A lithium ion secondary battery was produced in the same manner as in Example 1-1 except that the median diameter of Al₂O₃ particles was changed to 47 nm.

### Example 3-3

A lithium ion secondary battery was produced in the same manner as in Example 1-1 except that the median diameter of Al₂O₃ particles was changed to 50 nm.

### Example 3-4

A lithium ion secondary battery was produced in the same manner as in Example 1-1 except that the median diameter of Al₂O₃ particles was changed to 55 nm.

### Example 3-5

A lithium ion secondary battery was produced in the same manner as in Example 1-1 except that the median diameter of Al₂O₃ particles was changed to 85 nm.

### Example 3-6

A lithium ion secondary battery was produced in the same manner as in Example 1-1 except that the median diameter of Al₂O₃ particles was changed to 700 nm.

### Comparative Example 3-1

A lithium ion secondary battery was produced in the same manner as in Example 1-1 except that the median diameter of Al₂O₃ particles was changed to 1000 nm.

(Measurement of Capacity Retaining Factor)

Each lithium ion secondary battery produced in Examples 3-1 to 3-6 and Comparative Example 3-1 was subjected to charge and discharge operations, to examine its capacity retaining factors in the first cycle and 100th cycle by using the same method that was used in Example 1, to find the capacity retaining factor after 100 cycles.

The capacity retaining factor after 100 cycles in each Example and Comparative Example is shown in Table 3 below.

TABLE 3

| | | | | THICKNESS OF | | |
|---|---|---|---|---|---|---|
| | CERAMIC | | | THE COATING FILM | | CAPACITY |
| | | MEDIAN | CONTENT | ON ONE SURFACE | VOLUME DENSITY | RETAINING |
| | | DIAMETER | [PARTS | OF THE CATHODE | OF THE CATHODE | FACTOR AFTER |
| | TYPE | [nm] | BY WEIGHT] | [μm] | [g/cm³] | 100 CYCLES [%] |
| EXAMPLE 3-1 | Al₂O₃ | 12 | 0.5 | 102 | 3.56 | 95.2 |
| EXAMPLE 3-2 | Al₂O₃ | 47 | 0.5 | 102 | 3.56 | 90.1 |
| EXAMPLE 3-3 | Al₂O₃ | 50 | 0.5 | 102 | 3.56 | 86.3 |
| EXAMPLE 3-4 | Al₂O₃ | 55 | 0.5 | 102 | 3.56 | 71.5 |
| EXAMPLE 3-5 | Al₂O₃ | 85 | 0.5 | 102 | 3.56 | 67.1 |
| EXAMPLE 3-6 | Al₂O₃ | 700 | 0.5 | 102 | 3.56 | 52.8 |
| COMPARATIVE | Al₂O₃ | 1000 | 0.5 | 102 | 3.56 | 37.6 |
| EXAMPLE 3-1 | | | | | | |

As shown in Table 3, it is found that Examples 3-1 to 3-6 containing Al₂O₃ having a median diameter less than 1 μm (1000 nm) are more improved in capacity retaining factor than Comparative Example 3-1 using Al₂O₃ having a median diameter of 1 μm. Particularly, Examples 3-1 to 3-3 having a median diameter of 50 nm or less are significantly improved in capacity retaining factor. Also, when the median diameter is 12 nm or less as shown in the case of Example 3-1, a higher capacity retaining factor can be obtained.

Though Examples 3-4 to 3-6, in turn, were found to be improved in capacity retaining factor, such an effect obtained in Examples 3-1 to 3-3 was not found. This is because ionic diffusibility can be only insufficiently improved since the particle diameter of Al₂O₃ particles is large and therefore largely exceeds the thickness of the cathode film having a thickness of several nm, and thus the ionic diffusibility in the cathode film is not sufficiently improved. Also, large Al₂O₃ particles which are insulating materials exist between the active material particles, bringing about a reduction in electroconductivity and an outstanding improvement in capacity retaining factor is not therefore expected.

Also, in the case of Comparative Example 3-1 in which the median diameter is 1 μm (1000 nm), the particle diameter of Al₂O₃ particles is so large that electroconductivity between the cathode active material particles is hindered, resulting in deteriorated cycle characteristics.

It is clarified from this result that a significant effect can be obtained when the median diameter of Al₂O₃ to be contained is 50 nm or less, and more significant effect can be obtained when the median diameter of Al₂O₃ is 12 nm or less.

Also, in the case of ceramics such as SiO₂, ZrO₂, MgO, Na₂O and TiO₂, other than Al₂O₃, the capacity retaining factor can be improved by making the anode contain ceramics having a median diameter less than 1 μm. Particularly, in the case where these ceramics have a median diameter of 50 nm or less, a significant effect can be obtained. Also, in the case where these ceramics have a median diameter of 12 nm or less, a more significant effect can be obtained.

### Example 4

Using Al₂O₃ as the ceramic to be contained in the cathode, the thickness of the cathode active material layer formed on the cathode current collector was changed and the ceramic was added to produce lithium ion secondary batteries and the capacity retaining factor of each battery after 100 cycles was measured.

### Example 4-1

A lithium ion secondary battery was produced in the same manner as in Example 1-1 except that the thickness of the cathode active material layer on one surface was changed to 62 μm.

### Example 4-2

A lithium ion secondary battery was produced in the same manner as in Example 1-1 except that the thickness of the cathode active material layer on one surface was changed to 70 μm.

### Example 4-3

A lithium ion secondary battery was produced in the same manner as in Example 1-1 except that the thickness of the cathode active material layer on one surface was changed to 130 μm.

### Example 4-4

A lithium ion secondary battery was produced in the same manner as in Example 1-1 except that the thickness of the cathode active material layer on one surface was changed to 135 μm.

### Comparative Example 4-1

A lithium ion secondary battery was produced in the same manner as in Example 1-1 except that the thickness of the cathode active material layer on one surface was changed to 62 μm and Al₂O₃ was not contained.

### Comparative Example 4-2

A lithium ion secondary battery was produced in the same manner as in Example 1-1 except that the thickness of the cathode active material layer on one surface was changed to 70 μm and Al₂O₃ was not contained.

### Comparative Example 4-3

A lithium ion secondary battery was produced in the same manner as in Example 1-1 except that the thickness of the cathode active material layer on one surface was changed to 130 μm and Al₂O₃ was not contained.

### Comparative Example 4-4

A lithium ion secondary battery was produced in the same manner as in Example 1-1 except that the thickness of the cathode active material layer on one surface was changed to 135 μm and Al₂O₃ was not contained.

(Measurement of Capacity Retaining Factor)

Each lithium ion secondary battery produced in Examples 4-1 to 4-4 and Comparative Example 4-1 to 4-4 was subjected to charge and discharge operations, to examine its capacity retaining factors in the first cycle and 100th cycle by using the same method that was used in Example 1, to find the capacity retaining factor after 100 cycles.

The capacity retaining factor after 100 cycles in each Example and Comparative Example is shown in Table 4 below.

TABLE 4

| | | | | THICKNESS OF | | |
|---|---|---|---|---|---|---|
| | CERAMIC | | | THE COATING FILM | | CAPACITY |
| | | MEDIAN | CONTENT | ON ONE SURFACE | VOLUME DENSITY | RETAINING |
| | | DIAMETER | [PARTS | OF THE CATHODE | OF THE CATHODE | FACTOR AFTER |
| | TYPE | [nm] | BY WEIGHT] | [μm] | [g/cm³] | 100 CYCLES [%] |
| EXAMPLE 4-1 | Al₂O₃ | 25 | 0.5 | 62 | 3.56 | 92.1 |
| EXAMPLE 4-2 | Al₂O₃ | 25 | 0.5 | 70 | 3.56 | 91.2 |
| EXAMPLE 4-3 | Al₂O₃ | 25 | 0.5 | 130 | 3.56 | 85.8 |
| EXAMPLE 4-4 | Al₂O₃ | 25 | 0.5 | 135 | 3.56 | 65.3 |
| COMPARATIVE | — | — | 0 | 62 | 3.56 | 85.0 |
| EXAMPLE 4-1 | | | | | | |
| COMPARATIVE | — | — | 0 | 70 | 3.56 | 70.2 |
| EXAMPLE 4-2 | | | | | | |
| COMPARATIVE | — | — | 0 | 130 | 3.56 | 52.4 |
| EXAMPLE 4-3 | | | | | | |
| COMPARATIVE | — | — | 0 | 135 | 3.56 | 42.3 |
| EXAMPLE 4-4 | | | | | | |

It is found that in the case of Examples 4-1 to 4-4 and Comparative Examples 4-1 to 4-4 each provided with the cathode active material layer changed in thickness, the capacity retaining factor can be improved regardless of thickness by adding Al₂O₃ nano-particles as shown in Table 4, and that a particularly significant effect is obtained when the thickness of the cathode active material layer on one surface is 70 μm or more and 130 μm or less.

In the case of Example 4-1 in which the thickness of the cathode active material layer was 62 μm and Example 4-4 in which the thickness of the cathode active material layer was 135 μm, on the other hand, such a significant effect that was obtained in Examples 4-2 and 4-3 was not observed, though an improvement in capacity retaining factor was found.

This reason is that because, in Example 4-1, the cathode active material layer is thin and the capacity retaining factor is not originally low, the effect of Al₂O₃ is weakened though the capacity retaining factor is improved by adding Al₂O₃, while in Example 4-4, the cathode active material layer is so thick that the effect of adding Al₂O₃ is insufficiently produced resultantly.

From this result, the thickness of the anode active material layer on one surface is preferably designed to be 70 μm or more and 130 μm or less when Al₂O₃ nano-particles are contained.

In the case of ceramics such as SiO₂, ZrO₂, MgO, Na₂O and TiO₂ other than Al₂O₃, the capacity retaining factor can be likewise remarkably improved and a high effect is obtained by designing the thickness of the anode active material layer on one surface to be 70 μm or more and 130 μm or less.

It should be understood by those skilled in the art that various modifications, combinations, sub-combinations and alternations may occur depending on design requirements and other factors insofar as they are within the scope of the appended claims or the equivalents thereof.

For example, the values given in the above embodiment are only examples and values different from the above values may be used according to the need.

Also, in the above embodiments, examples are given of a cylindrical battery using an electrolyte solution. However, it should be appreciated that the embodiments may be applied to any battery insofar as the battery uses, as its cathode, a cathode active material capable of occluding and releasing lithium ions. Though the embodiments may be applied to a battery using a gel electrolyte, the effect of the embodiments can be obtained in particular when it is applied to batteries using an electrolyte solution.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A lithium ion battery comprising:
a cathode including a cathode active material layer on a cathode current collector;
an anode; and
an electrolyte solution,
wherein the cathode active material layer contains nano-particles of ceramic.

2. The lithium ion battery according to claim 1, wherein the ceramic is at least one kind selected from the group consisting of Al₂O₃, SiO₂, ZrO₂, MgO, Na₂O and TiO₂.

3. The lithium ion battery according to claim 1, wherein the ceramic is Al₂O₃.

4. The lithium ion battery according to claim 1, wherein the content of the ceramic is 0.1 parts by weight or more and 1.0 parts by weight or less for 100 parts by weight of the cathode active material.

5. The lithium ion battery according to claim 1, wherein the median diameter of the ceramic is 50 nm or less.

6. The lithium ion battery according to claim 1, wherein the median diameter of the ceramic is 12 nm or less.

7. The lithium ion battery according to claim 1, wherein the thickness of the cathode active material layer provided on one surface of the cathode current collector is 70 μm or more and 130 μm or less.
